(19) United States
(12) Patent Application Publication
(10) Pub. No.: US 2010/0235426 A1
(43) Pub. Date: Sep. 16, 2010

(54) SERVER FOR PROVIDING PRESENTITY STATUS AND METHOD THEREOF

(75) Inventor: Yi-Wen Chang, Taipei (TW)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/279,746

(22) PCT Filed: Mar. 28, 2007
(86) PCT No.: PCT/JP2007/057504

§ 371 Date: Aug. 18, 2008

(30) Foreign Application Priority Data
Mar. 29, 2006 (CN) 200610067997.8

(51) Int. Cl. G06F 15/16

(52) U.S. Cl. 709/203

(57) ABSTRACT

A server for providing presentity status is adapted to provide the latest status of a presentity to a watcher. The presentity and the watcher are respectively connected to a connection server through a network. The presentity belongs to at least one group, and the watcher also belongs to at least one group. The connection server can detect the latest status of the groups to which the presentity belongs. The server for providing presentity status automatically determines the provision of the status of the presentity to the watcher based on whether the respective authority values of the groups to which the presentity belongs and the respective authority values of the groups to which the watcher belongs satisfy a preset condition. When the preset condition is satisfied, the server for providing presentity status also sends the latest status of other presentities that belong to the same groups as the presentity and that are subscribed to by the watcher to the watcher.

### TECHNICAL FIELD

The invention relates to a server for providing presentity status and a method for providing presentity status, and more particularly to a server and method for providing presentity status to a watcher according to authority values of the groups to which the presentity and the watcher respectively belong.

### BACKGROUND ART

Referring to FIG. 1, a plurality of presentities A to E are connected to a communications network 10, and set up connections with other presentities through a connection server 11 that is electrically connected to the communications network 10. The connections may be one-to-one connections, or multi-party connections. Each of the presentities A to E belongs to more than one group (be they in the same group or different groups), e.g., acting as a member of an organization.

Each presentity has to send a connection request to the connection server 11 when setting up a connection, where the connection server 11 is responsible for setting up connections between one presentity and other presentities. The communications network 10 may be Voice over Internet Protocol (VoIP) of a network phone, an instant messaging connection network, or a communications network of a conventional cell phone. The connection server 11 may be a push-to-talk over cellular (PoC) server without being limited thereto.

When the presentity A connects to the network, the presentity A may want to know other currently available presentities so as to understand with which presentities a connection can be set up. Through a status server 12 electrically connected to the communications network 10 and providing current status of the presentities, the presentities can exchange their current status, e.g., whether the presentities are currently participating in a conference, out, busy, temporarily unavailable, etc.

Therefore, for other presentities, the presentity A is a watcher who watches their current status and wants to obtain their current status. The presentity A sends a watch request to the status server 12 to subscribe to the status of other presentities. The presentities on which the presentity A wants to watch decide whether or not to make public their status without reservation or only partly to the presentity A. Certainly, the status of the presentity A may also be watched by other presentities.

After a watcher has completed the subscription to the current status of another presentity, if the status of the presentity being watched changes, the status server 12 will notify the watcher of the change, so that the watcher can be made aware of the change in the status of another presentity in real time.

A presentity may determine whether all of or a part of the status thereof is to be provided to a watcher, which is often based on mutual relationship between the presentity and the watcher, e.g., whether there is a subordination relationship or a family relationship therebetween.

An example is cited herein for illustrative purposes. Referring to FIG. 2, it is supposed that the presentities A to E are members of an organization, and are third- or fourth-graded members according to a subordination relationship. Since the presentity A has a higher rank, the status of the presentity A will not normally be provided to the members B to E of a lower rank, but is instead made known to members of a rank or ranks not lower than that of the presentity A. Alternatively, the presentity A provides a part of the status thereof to the subordinate members B to E of a lower rank, but does not provide all of the status thereof to the non-subordinate members of a lower rank. Therefore, the presentity A must set many determination conditions in the status server 12, for example the watcher can know all his/her status when the watcher belongs to a certain group in a certain department and is of a higher rank than his/her (i.e., the presentity A), the watcher can only learn of a part of the status when the watcher belongs to another department, etc., so that the status server 12 can screen the status information to be obtained by other presentities according to these determination conditions. Therefore, every presentity must understand the ranking relationship of the entire organization, and must also set different conditions for every other presentity, so that the status server 12 can provide his/her status to other presentities according to the conditions thus set.

However, an organization is often huge, and the number of presentities connected to the communications network 10 is quite large. It is a very difficult task for a presentity to understand the relative ranking relationships between himself/herself and other members of the entire organization. Furthermore, the ranking relationship among the members of an organization may be changed or modified from time to time according to duty requirements. For example, for the presentity A, when a watcher B who was originally a subordinate thereof rises to the same rank as that of the presentity A, it may be necessary to provide more status information to the watcher B. Sometimes, members of the same rank may be reorganized into smaller units according to their duties, and the presentity may then need to reset determination conditions which screen the status information that each watcher can obtain. Therefore, it is very difficult for every presentity to clearly confirm his/her relationships with other presentities, and the determination conditions often have to be revised from time to time according to changes in the organization even after confirmation. This will cause inconvenience in use.

Therefore, in order to provide the status of the presentities to their watchers, the prior art often needs to set and compare many complicated rules and determination conditions so as to determine the relationship of every presentity with all his/her watchers and their respective authority values, thereby resulting in reduced operating efficiency.

### DISCLOSURE OF INVENTION

Therefore, an object of the present invention is to provide a server for providing presentity status. The server for providing presentity status can enhance operating efficiency.

Another object of the present invention is to provide a method for providing presentity status. The method automatically determines the provision of the status of a presentity to a watcher according to the relationship between the group to which the presentity belongs and the group to which the watcher belongs.

Accordingly, the server for providing presentity status of this invention is adapted to provide the latest status of a presentity to a watcher. The presentity and the watcher are connected to a connection server through a network. The presentity belongs to at least one group and the watcher also belongs to at least one group. The connection server can detect the latest status of the groups to which the presentity belongs. The server for providing presentity status includes a database unit, a transmission unit, a presentity status checking unit, an authority comparison unit, and a status updating unit.

The database unit respectively stores the current status of the groups to which the presentity belongs.

The transmission unit is electrically connected to the connection server, and receives the latest status of the groups to which the presentity belongs through the connection server when a preset situation is satisfied.

The presentity status checking unit is electrically connected to the transmission unit, receives the latest status of the groups to which the presentity belongs through the transmission unit, and updates the status in the database unit according to the received latest status.

The authority comparison unit compares the highest authority value of the groups to which the watcher belongs and the respective authority values of the groups to which the presentity belongs.

The status updating unit is electrically connected to the authority comparison unit, the database unit, and the transmission unit, receives a comparison result from the authority comparison unit, and when the comparison result satisfies a preset condition, sends the latest status of the presentity in the groups to which the presentity belongs as recorded in the database unit to the watcher through the transmission unit.

Accordingly, the method employed by the server for providing presentity status of the present invention includes the following steps:

(A) when a preset situation is satisfied, the connection server receiving the latest status of the groups to which the presentity belongs;

(B) comparing the highest authority value of the groups to which the watcher belongs with the respective authority values of the groups to which the presentity belongs; and

(C) when the highest authority value of the groups to which the watcher belongs and the respective authority values of the groups to which the presentity belongs satisfies a preset condition, sending the latest status of the presentity in the groups thereof to the watcher.

### BRIEF DESCRIPTION OF DRAWINGS

Other features and advantages of the present invention will become apparent in the following detailed description of the preferred embodiment with reference to the accompanying drawings, of which:

FIG. 1 is a schematic diagram to illustrate the electrical connection among a server for providing status, a connection server, and a plurality of presentities;

FIG. 2 is an organizational hierarchy diagram;

FIG. 3 is a circuit block diagram of a server for providing status according to the present invention;

FIG. 4 shows contents stored in a group configuration database;

FIG. 5 shows contents stored in a list database;

FIGS. 6A and 6B are flowcharts of a method for providing presentity status according to the present invention;

FIG. 7 shows the contents stored in the group configuration database after presentities A, B and C belonging to a group G2 have started a conference;

FIG. 8 shows the contents stored in the list database after the presentities A, B and C belonging to the group G2 have started a conference;

FIG. 9 shows status of other presentities as obtained by the presentities A to E after the presentities A, B and C belonging to the group G2 have started a conference;

FIG. 10 shows the contents stored in the group configuration database after the presentities A, B, C, and D belonging to the group G2 have started a conference;

FIG. 11 shows the contents stored in the list database after the presentities A, B, C, and D belonging to the group G2 have started a conference;

FIG. 12 shows the status of the other presentities as obtained by the presentities A to E after the presentities A, B, C, and D belonging to the group G2 have started a conference;

FIG. 13 shows the contents stored in the group configuration database after the presentities A, C, and D belonging to a group G1 have started a conference;

FIG. 14 shows the contents stored in the list database after the presentities A, C, and D belonging to the group G1 have started a conference; and

FIG. 15 shows the status of the other presentities as obtained by the presentities A to E after the presentities A, C, and D belonging to the group G1 have started a conference.

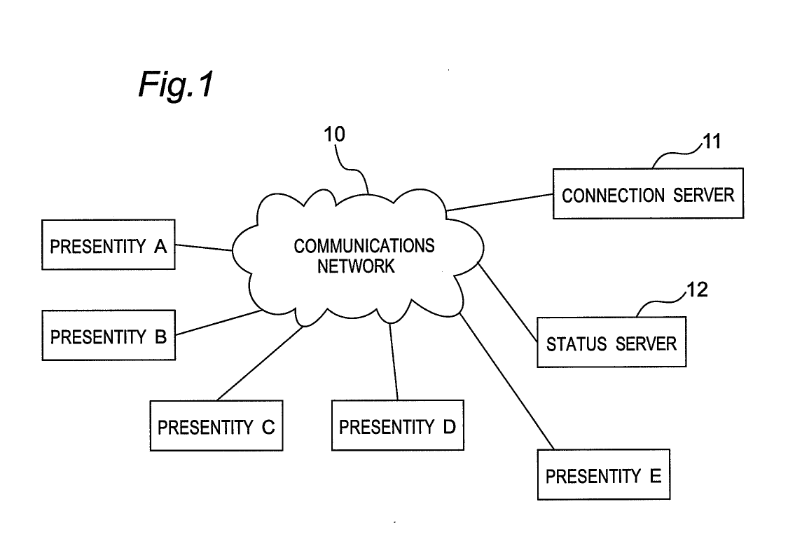

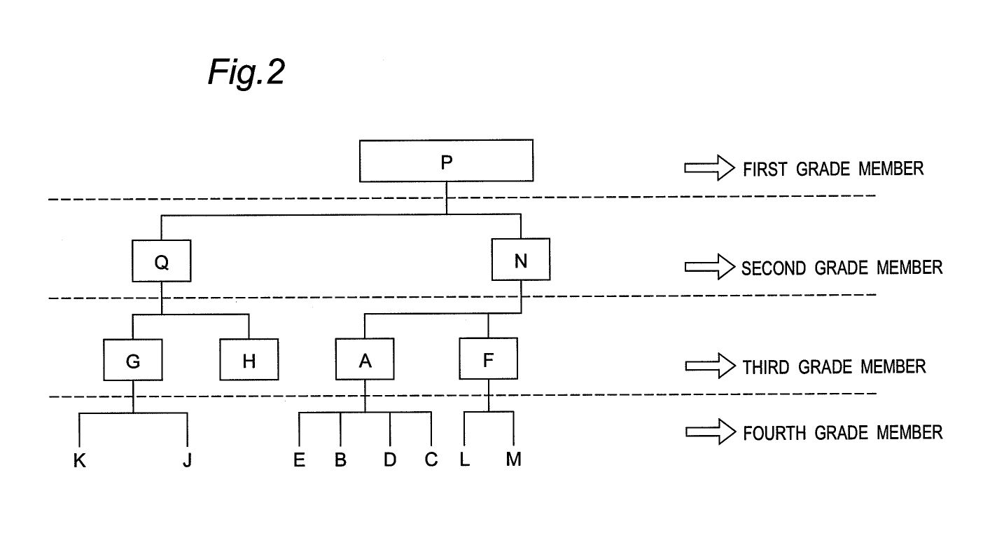

### BEST MODE FOR CARRYING OUT THE INVENTION

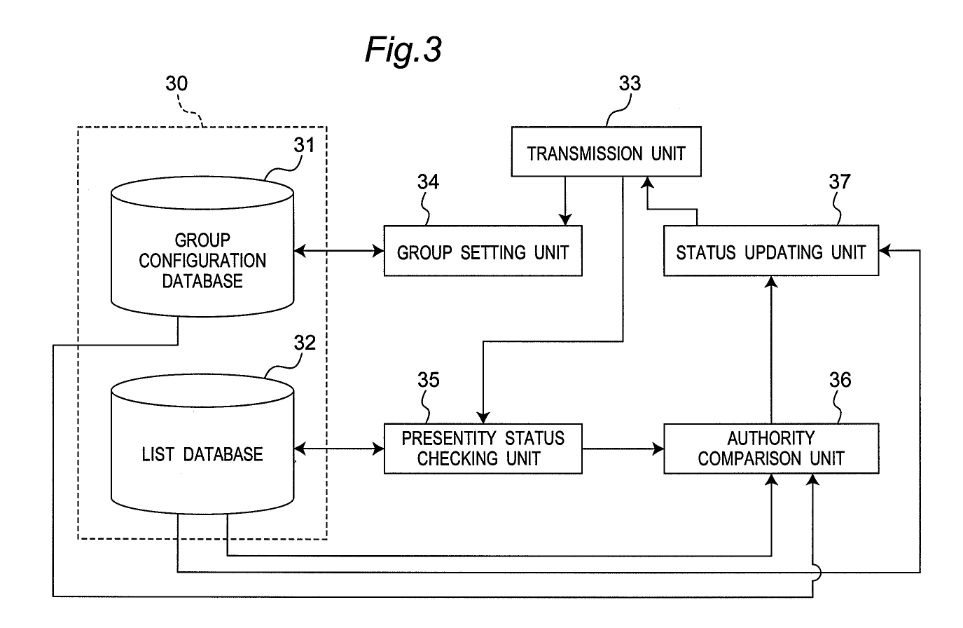

Referring to FIGS. 3 to 5, the preferred embodiment of a server for providing presentity status according to the present invention is adapted to provide the status of a plurality of presentities that are connected to a communications network. The presentities set up the connections through a connection server (not shown) electrically connected to the communications network. The server for providing presentity status includes a database unit 30, a transmission unit 33, a group setting unit 34, a presentity status checking unit 35, an authority comparison unit 36 and a status updating unit 37. The database unit 30 includes a group configuration database 31 and a presentity status and watcher list database 32 (which is referred to hereinafter as the list database 32 in short so as to facilitate description).

The transmission unit 33 receives group setting information issued by the connection server or set by an administrator of the communications network, receives the latest status of the groups from the connection server, and receives watch requests sent from each watcher. Each watch request includes a presentity list subscribed to by the watcher. The group setting information includes a presentity list of each group, status of each group, and authority value of each group. The authority value of a group may be preset by the administrator of the connection server, and is stored in the connection server to be subsequently transmitted to the transmission unit 33, or may be set directly by the administrator to be transmitted to the transmission unit 33.

The group setting unit 34 sets the presentity list of each group, the status of each group, and the authority value of each group according to the group setting information received from the transmission unit 33, and stores the same in the group configuration database 31. The group setting unit 34 further updates the group status stored in the group configuration database 31 according to the latest status of the groups received from the transmission unit 33. When the status of a group changes, e.g., when presentities belonging to the group start or end a conference, the transmission unit 33 will receive the corresponding latest status of the group from the connection server.

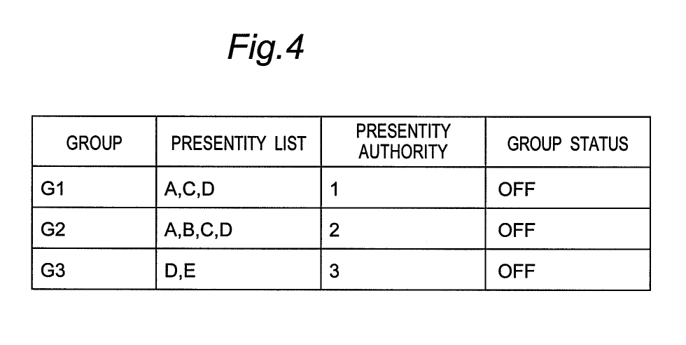

The group configuration database 31 stores the presentity list of each group, the authority value of each group, and the status of each group. FIG. 4 shows the contents stored in the group configuration database 31: Group G1 includes presentities A, C, and D; group G2 includes presentities A, B, C, and D; and group G3 includes presentities D and E. The authority values of the groups G1, G2, and G3 are 1, 2, and 3, respectively. In the preferred embodiment of this invention, the group with an authority value 1 has the highest authority, and, without limiting the present invention, the authority of the group becomes more restricted with an increase in the authority value. Assuming the presentities of each group have yet to start a conference, the initial status of each of the groups G1, G2 and G3 is “off.”

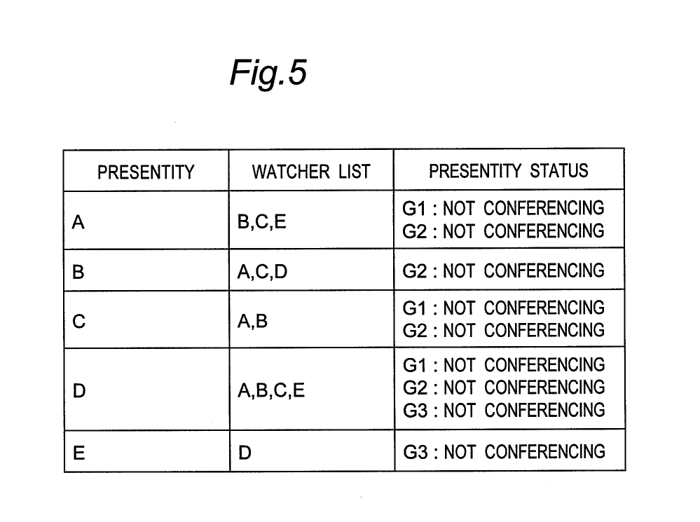

The list database 32 stores the status of every presentity in a group, and a list of watchers subscribing to the status of each presentity. FIG. 5 shows the contents of the list database 32. Supposing three of the presentities, namely, B, C, and E, have each sent a watch request with respect to the presentity A, the watcher list of the presentity A will include watchers B, C, and E. The watcher lists of the other presentities are also shown in FIG. 5. The column on the rightmost side of FIG. 5 shows the status of every presentity in each group. For example, the presentity D belongs to three groups, G1, G2, and G3, with a “no conferencing” status for each of the groups G1, G2, and G3.

The presentity status checking unit 35 sets the watcher list of each presentity in the list database 32 according to the presentity lists subscribed to by the watchers and received from the transmission unit 33. The presentity status checking unit 35 further updates the latest status of each presentity in the groups in the list database 32 according to the latest status of the groups received from the transmission unit 33.

Furthermore, according to the updated list database 32, the presentity status checking unit 35 organizes for the presentities whose status has changed a list of groups that these presentities belong to and have joined, and sends the list of groups to the authority comparison unit 36. The list of groups includes the current status of the groups that these presentities belong to and have joined.

For instance, if a status change occurs in group G2 of FIG. 5, i.e., the presentities A, C, and D belonging to the group join the group G2, the presentity status checking unit 35, according to the change in status of the presentities A, C, and D in the group G2, stores the updated status of the presentities A, C, and D in the list database 32, and generates respective lists of groups for the presentities A, C, and D that they respectively belong to and have joined. The list of groups that the presentity A belongs to and has joined will include group G2. The list of groups that the presentity C belongs to and has joined will include group G2. The list of groups that the presentity D belongs to and has joined will include group G2.

The authority comparison unit 36 receives the lists of groups organized by the presentity status checking unit 35, inquires about the watcher list in the list database 32, and about the group authority in the group configuration database 31 so as to compare the highest authority value of the groups that a watcher belongs to with the authority value of each group in the list of groups that the presentity belongs to and has joined, and sends the comparison result to the status updating unit 37. When a watcher belongs to a plurality of groups, the highest authority value of the groups to which the watcher belongs will be used as the highest authority value of the watcher. For example, the groups G1 and G2 to which the presentity A in FIG. 4 belongs have authority values of 1 and 2, respectively. Therefore, when the presentity A watches the other presentities, the watcher A has the highest authority value 1.

The status updating unit 37 receives the authority comparison result from the authority comparison unit 36 so as to determine whether or not to send the status of the presentity in one group to the watcher according to the contents of the list database 32, i.e., if the authority comparison unit 36 finds that the authority value of a group that a presentity belongs to and has joined is not higher than the highest authority value of the watcher, the status updating unit 37 will provide the status of the presentity in the group and the status of the group, e.g., the other presentities that have joined the group, to the watcher through the transmission unit 33. If the authority comparison unit 36 finds that the authority value of a group that a presentity belongs to and has joined is higher than the highest authority value of the watcher, the status updating unit 37 will not provide the status of the presentity in the group and the status of the group to the watcher through the transmission unit 33.

An example is cited here for illustrative purposes. Referring to FIGS. 4 and 5, the status of the presentity D is subscribed to by the watcher B, and the list of groups that the presentity D belongs to and has joined include groups G1 to G3. In addition, the highest authority value of the watcher B is 2. When a change occurs in the status of the presentity D in the group G2, since the respective authority values of the groups G2 and G3 are not higher than the authority value 2 of the watcher B, the status of the presentity D in the groups G2 and G3 will be provided to the watcher B, whereas the status of the presentity D in the group G1 will not be provided to the watcher B.

In addition, when the status of a presentity in a group to which he/she belongs is provided to the watcher, the status will only show the presentities subscribed to by the watcher. For example, in FIG. 4, the watcher B watches the presentity D. When a change occurs in the status of the presentity D in the group G3, since the authority value of the watcher B is 2, the status of the presentity D in the group G3 which the watcher B obtains will merely show the status of the presentity D in the group G3, without showing the presentity E not subscribed to by the watcher B.

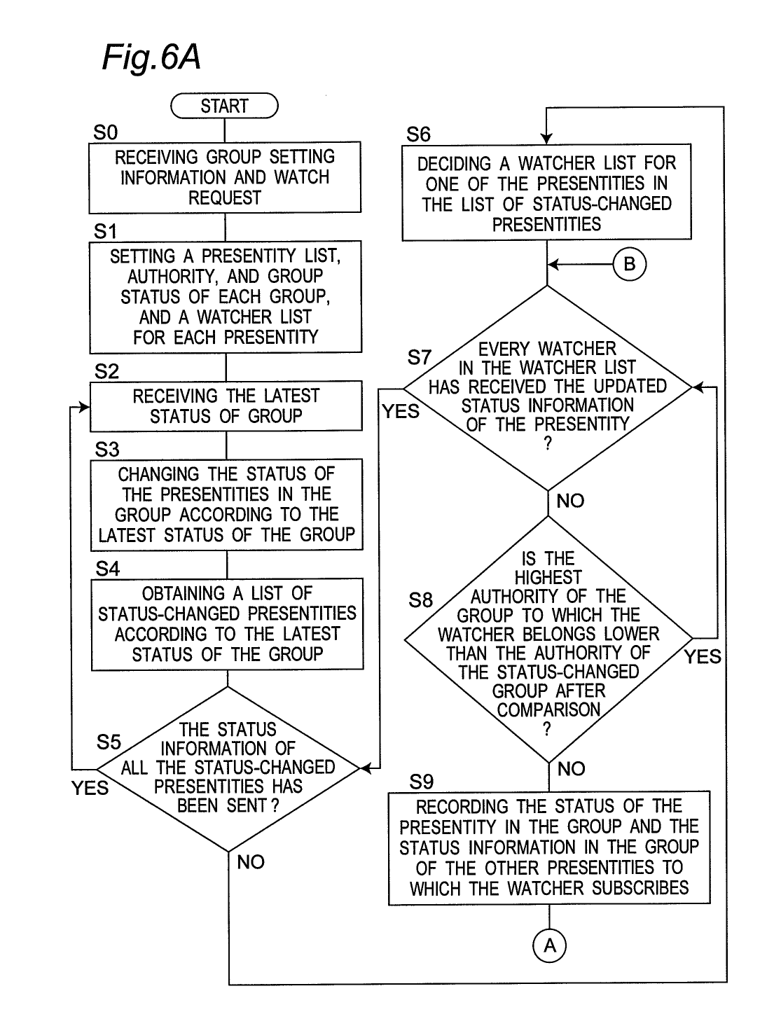

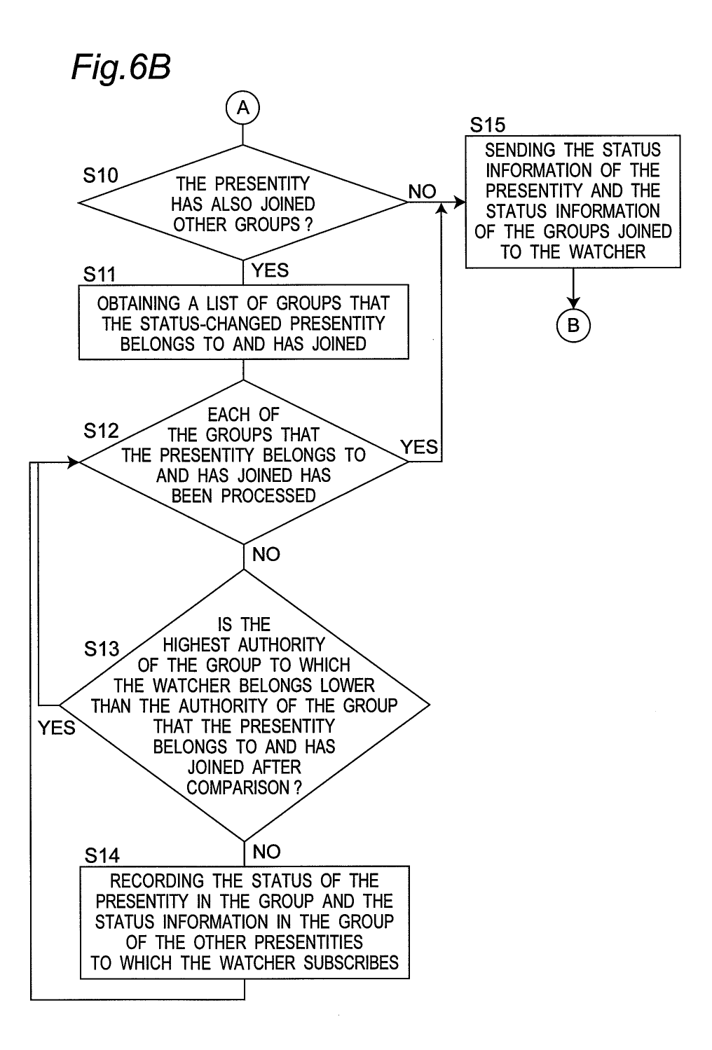

Referring to FIGS. 3, 6A and 6B, a method employed by the server for providing status of a presentity according to the present invention includes the following steps:

In step S0, the transmission unit 33 receives group setting information and a list of presentities that the watcher subscribes to from the connection server.

In step S1, the group setting unit 34 sets a list of presentities belonging to each group, the authority of each group, and the status of each group in the group configuration database 31 according to the group setting information received from the transmission unit 33. Moreover, in this step, the presentity status checking unit 35 also sets a watcher list for each presentity in the list database 32 according to the list of presentities subscribed to by the watchers as received by the transmission unit 33.

In step S2, the transmission unit 33 receives the latest status of the groups from the connection server. Moreover, in this step, the group setting unit 34 updates the group status in the group configuration database 31 according to the latest status.

In step S3, the presentity status checking unit 35 receives the latest status of the groups from the transmission unit 33, and makes corresponding changes to the status of the presentities, whose current status have also changed in the list database 32 according to the latest status of the groups.

In step S4, the presentity status checking unit 35 obtains a list of status-changed presentities according to the latest status of the groups.

In step S5, the presentity status checking unit 35 checks whether the status of each status-changed presentity in the list of status-changed presentities has been sent to all the watchers thereof. If yes, step S2 is performed. Otherwise, the flow goes to step S6.

In step S6, the authority comparison unit 36 obtains a watcher list for each presentity in the list of status-changed presentities according to the contents of the list database 32.

In step S7, the authority comparison unit 36 checks whether all the watchers in the watcher list obtained in step S6 have obtained the latest status of the status-changed presentity. If yes, step S5 is performed. Otherwise, step S8 is carried out.

In step S8, the authority comparison unit 36 performs a comparison to determine whether the highest authority value of the groups to which one watcher in the watcher list belongs is lower than the authority value of the status-changed group according to the contents of the group configuration database 31. If yes, step S7 is performed. Otherwise, step S9 is carried out.

In step S9, the status updating unit 37 records the status of the status-changed presentities in the group, and the status of other presentities in the same status-changed group subscribed to by the watcher in step S8.

In step S10, the presentity status checking unit 35 checks whether the status-changed presentity in the list database 32 has joined other groups. If yes, step S11 is performed. Otherwise, step S15 is carried out.

In step S11, the presentity status checking unit 35 obtains a list of groups that the status-changed presentity belongs to and has joined.

In step S12, the presentity status checking unit 35 checks whether each group in the list of groups that the status-changed presentity belongs to and has joined has been processed. If yes, step S15 is performed. Otherwise, step S13 is carried out.

In step S13, the authority comparison unit 36 makes a comparison to determine whether the highest authority value of the groups to which the watcher belongs is lower than the authority value of each group in the list of groups that the status-changed presentity belongs to and has joined. If yes, step S12 is performed. Otherwise, step S14 is carried out.

In step S14, the status updating unit 37 records the status of the status-changed presentity, as well as the status of other presentities subscribed to by the watcher, in each group in the list of groups that the status-changed presentity belongs to and has joined.

In step S15, the status updating unit 37 will send the status of the presentity in the status-changed group and the status of other groups in the list of the groups that the presentity belongs to and has joined to the watcher through the transmission unit 33.

It is noted that, in this preferred embodiment, the transmission unit 33 receives the latest status of the group through the connection server only when a preset situation is satisfied, and the status of the group in the group configuration database 31 is updated and the remaining steps are executed according to the latest status. The preset situation may include an elapsed time since the status was last sent to the watcher being greater than or equal to a specific time, the occurrence of a change in the authority value of a group to which the presentity belongs, the occurrence of a change in the authority value of a group to which the watcher belongs, or the occurrence of a change in the status of a group to which the presentity belongs (including the presentity's starting to join the conference of the group, the presentity's ending the conference of the group, the presentity's joining the group, the presentity's leaving the group, the presentity is set to join the group, or the presentity is set to be removed from the group).

In order to more clearly express the applications of this invention, another example is provided herein for illustrative purposes. Referring to FIGS. 3 to 6B, it is supposed that the available presentities are A to E.

According to step S0, the transmission unit 33 receives group setting information and a list of presentities that the watcher subscribes to from the connection server.

According to step S1, the group setting unit 34 and the presentity status checking unit 35 respectively set the contents of the group configuration database 31 as those shown in FIG. 4, and the contents of the list database 32 as those shown in FIG. 5. The presentity A belongs to groups G1 and G2, and has yet to start conferencing. Therefore, the status of the presentity A in groups G1 and G2 in FIG. 5 are both “no conferencing.” The presentity B belongs to group G2 only, and also has the “no-conferencing” status. The status of other presentities in their respective groups are listed on the rightmost column of FIG. 5.

Then, the presentities A, B and C belonging to the group G2 starts conferencing, and the connection server sends out the latest status of the group.

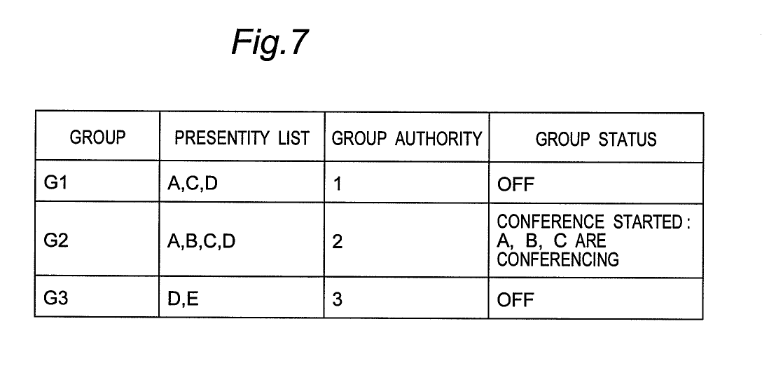

According to step S2, the group setting unit 34 updates the status of the group G2 in the group configuration database 31 according to the latest group status as “conference started: A, B and C are conferencing,” as shown in FIG. 7.

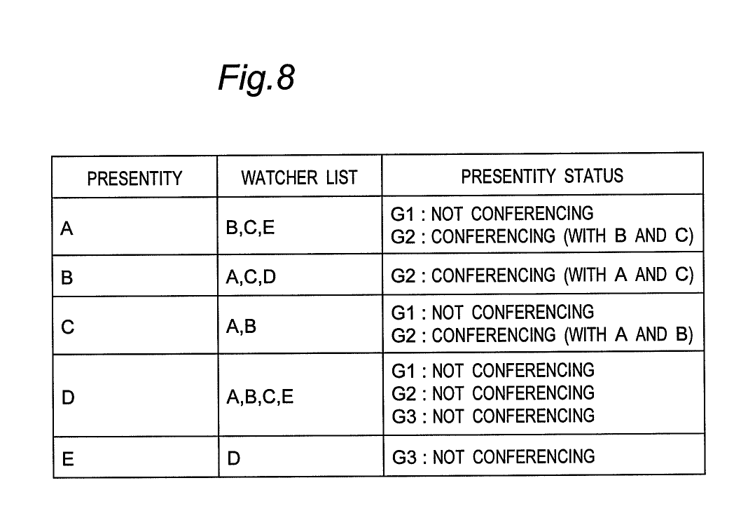

According to step S3, the presentity status checking unit 35 updates the list database 32 according to the latest group status so as to correct the status of the presentities A, B and C in the group G2 as “conferencing with B and C,” “conferencing with A and C,” and “conferencing with A and B,” respectively. Thus, the contents of the list database 32 are as shown in FIG. 8.

According to step S4, the presentity status checking unit 35 makes a list of status-changed presentities according to the latest status of the group. The list of presentities includes the presentities A, B and C in the status-changed group G2. It is noted that because the presentity D in the group G2 has yet to join the conference, the list of status-changed presentities does not include the presentity D.

According to step S5, the presentity status checking unit 35 has found that the status of the presentities A, B and C have yet to be sent to any watcher at this time. The flow then goes to step S6.

According to step S6, the authority comparison unit 36 obtains a watcher list for the presentity A, which includes watchers B, C and E.

According to step S7, the authority comparison unit 36 determines that none of the watchers B, C and E in the watcher list has received the latest status of the presentity A. The flow then goes to step S8.

According to step S8, since the group G2 to which the watcher B belongs has an authority value of 2, the authority comparison unit 36 sets the authority value of the watcher B as 2. Therefore, for the presentity A, the authority value 2 of the watcher B is not lower than the authority value 2 of the status-changed group G2. The flow then goes to step S9.

According to step S9, the status updating unit 37 records the status of the presentity A in the group G2. The status includes the status of the presentity A, and the status of another presentity C in the same group G2, which the watcher B also subscribes to.

According to step S10, the presentity status checking unit 35 finds from the contents of the list database 32 that the presentity A also belongs to the group G1. However, the group G1 is in an off state, so the flow skips to step S15.

According to step S15, the status updating unit 37 sends the status of the presentity A in the group G2, i.e., “conferencing with B and C,” to the watcher B through the transmission unit 33. The flow then returns to step S7.

According to step S7, the watcher C that watches the presentity A has yet to receive the status of the presentity A. The flow then goes to step S8.

According to step S8, since the groups G1 and G2 to which the watcher C belongs have the respective authority values of 1 and 2, the authority comparison unit 36 sets the authority value of the watcher C as 1. The authority comparison unit 36 finds that the authority value 1 of the watcher C is higher than the authority value 2 of the status-changed group. The flow then goes to step S9.

According to step S9, the status updating unit 37 records the status information of the presentity A in the group G2. The status information includes the status of the presentity A, and the status of another presentity B in the same group G2, which the watcher C also subscribes to.

According to step S10, the presentity status checking unit 35 finds from the contents of the list database 32 that the presentity A also belongs to the group G1. Because the group G1 is in an off state, the flow then skips to step S15.

According to step S15, the status updating unit 37 sends the status of the presentity A in the group G2, i.e., “conferencing with B and C,” to the watcher C through the transmission unit 33. The flow then returns to step S7.

According to step S7, the watcher E of the presentity A has yet to receive the status of the presentity A. The flow then goes to step S8.

According to step S8, the authority comparison unit 36 finds that the authority value 3 of the watcher E is lower than the authority value 2 of the status-changed group. The flow then returns to step S7.

According to step S7, the watchers B, C and E of the presentity A have all been checked. The flow then returns to step S5.

According to step S5, the presentity status checking unit 35 finds that the status of the status-changed presentities B and C in the status-changed group G2 have yet to be sent to their respective watchers at this time. The flow then goes to step S6.

According to step S6, the authority comparison unit 36 obtains a watcher list for the presentity B, which includes watchers A, C and D.

Then, according to steps S7 to S10, and step 15, the status updating unit 37 sends the status “conferencing with A and C” of the presentity B in the group G2 to the watchers A and C, and sends the status “conferencing” to the watcher D. It is noted that, since the watcher D does not subscribe to the status of the presentities A and C, the status of the presentity B which the status updating unit 37 sends to the watcher D does not include the status of the presentities A and C, and merely shows the status of the presentity B to be “conferencing.” The flow then goes to step S7.

According to step S7, the watchers A, C and D of the presentity B are all checked. The flow then returns to step S5.

According to step S5, the presentity status checking unit 35 finds that the status of the status-changed presentity C in the status-changed group G2 has yet to be sent to the corresponding watchers. The flow then goes to step S6.

According to step S6, the authority comparison unit 36 obtains a watcher list for the presentity C, which includes watchers A and B.

Then, according to steps S7 to S10, and step S15, the status updating unit 37 sends the status of the presentity C in the group G2, “conferencing with A and B,” to the watchers A and B. The flow then goes to step S7.

According to step S7, the watchers A and B of the presentity C are all checked. The flow then returns to step S5.

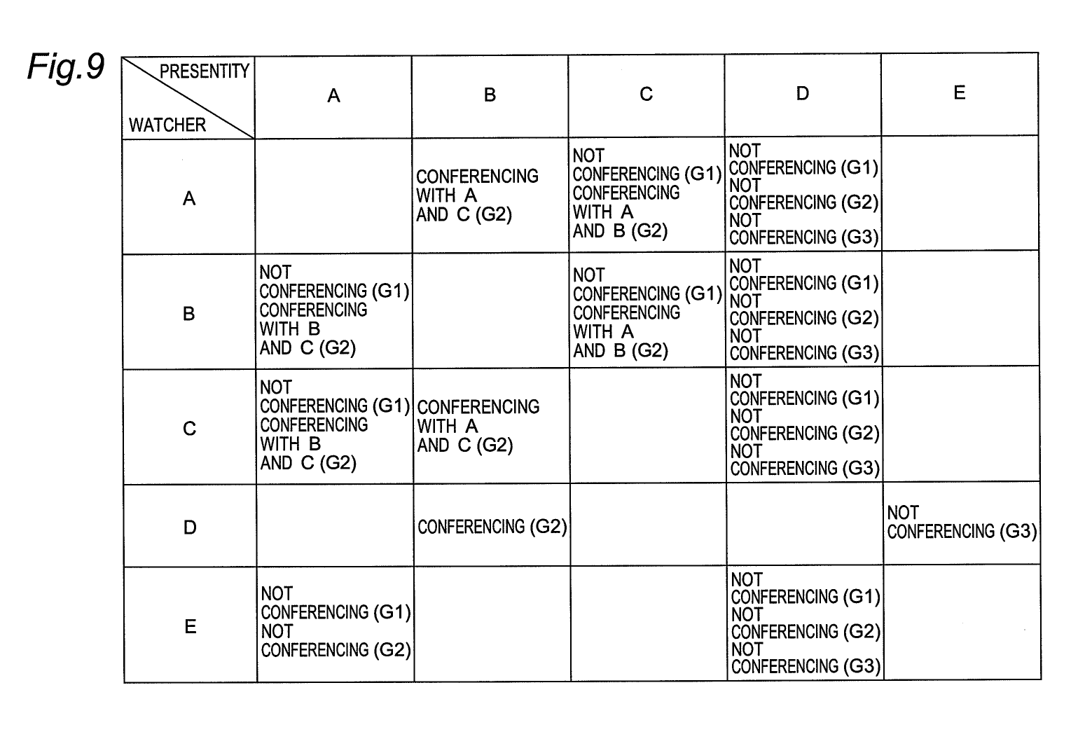

According to step S5, the status of the status-changed presentities A, B and C in the status-changed group G2 have all been sent to their respective watchers at this time. The flow then returns to step S2. The status of the presentities A to E in the groups G1 to G3 which the watchers A to E have obtained at this time are shown in FIG. 9.

Afterwards, the presentity D belonging to the group G2 also joins the conference of the other presentities A to C. Therefore, the connection server sends the latest group status of the group to the transmission unit 33.

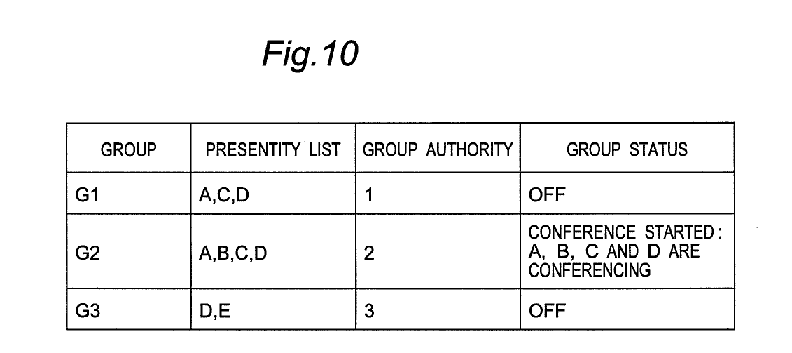

According to step S2, the group setting unit 34 updates the status of the group G2 in the group configuration database 31 according to the latest group status to the status “conference started: A, B, C and D are conferencing,” as shown in FIG. 10.

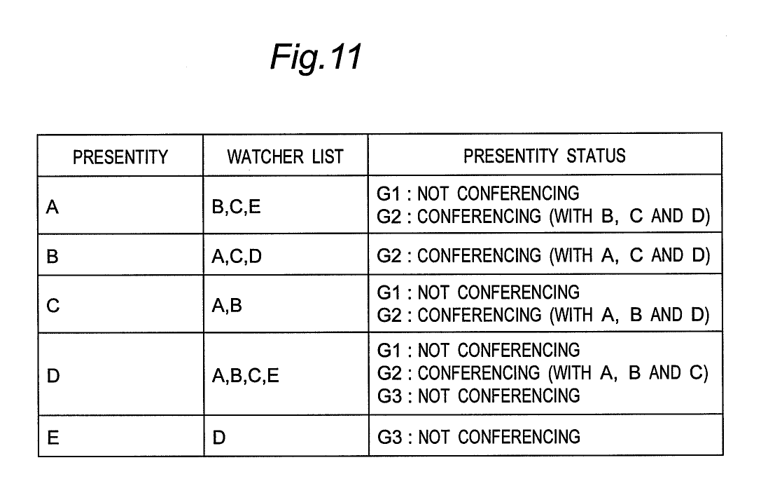

According to step S3, the presentity status checking unit 35 modifies the status of the presentities A to D in the group G2 according to the latest group status to “conferencing with B, C and D,” “conferencing with A, C and D,” “conferencing with A, B and D,” and “conferencing with A, B and C,” respectively. Thus, the contents of the list database 32 will be those as shown in FIG. 11.

According to step S4, the presentity status checking unit 35 makes a list of status-changed presentities according to the latest status of the group. The list of presentities includes the presentities A, B, C, and D belonging to the status-changed group G2.

According to step S5, the presentity status checking unit 35 finds that the status of all the status-changed presentities A, B, C, and D have yet to be sent to any watcher at this time. The flow then goes to step S6.

According to step S6, the authority comparison unit 36 obtains a watcher list for the presentity A, which includes watchers B, C and E.

Then, according to steps S7 to S10, and step S15, the status of the presentity A in the group G2 which the status updating unit 37 sends to each of the watchers B and C is “conferencing with B, C and D.” Since the watcher E belongs to the group G3 only and the authority value of the group G3 is 3, which is lower than the authority value 2 of the group G2, the status updating unit 37 does not send the status of the presentity A in the group G2 to the watcher E. The flow then goes to step S7.

According to step S7, the authority comparison unit 36 determines that the watchers B, C and E of the presentity A have all received the updated status. The flow then returns to step S5.

According to step S5, the presentity status checking unit 35 finds that the status of the status-changed presentities B, C and D in the status-changed group G2 have yet to be sent to their respective watchers at this time. The flow then goes to step S6.

According to step S6, the authority comparison unit 36 obtains a watcher list for the presentity B, which includes watchers A, C and D.

Then, according to steps S7 to S10, and step S15, the status updating unit 37 sends the status of the presentity B in the group G2, “conferencing with A, C and D,” to the watchers A and C, and sends the status of the presentity B in the group G2, “conferencing with D,” to the watcher D. It is noted that, since the watcher D subscribes to the status of the presentities B and E only, according to FIG. 11, the status information the watcher D obtains about the presentity B does not include the presentities A and C in the group G2. The flow then goes to step S7.

According to step S7, the watchers A, C and D of the presentity B are all checked. The flow then returns to step S5.

According to step S5, the presentity status checking unit 35 finds that the status of the status-changed presentities C and D in the status-changed group G2 have yet to be sent to their respective watchers at this time. The flow then goes to step S6.

According to step S6, the authority comparison unit 36 obtains a watcher list for the presentity C, which includes watchers A and B.

Then, according to steps S7 to S10, and step S15, the status updating unit 37 sends the status of the presentity C in the group G2, “conferencing with A, B and D,” to the watchers A and B. The flow then goes to step S7.

According to step S7, the watchers A and B of the presentity C are all checked. The flow then returns to step S5.

According to step S5, the presentity status checking unit 35 finds that the status of the status-changed presentity D in the status-changed group G2 has yet to be sent to the watchers thereof at this time. The flow then goes to step S6.

According to step S6, the authority comparison unit 36 obtains a watcher list for the presentity D, which includes watchers A, B, C, and E.

Then, according to steps S7 to S10, and step S15, the status updating unit 37 sends the status of the presentity D in the group G2, “conferencing with A, B and C,” to the watchers A, B and C. Since the watcher E belongs to the group G3 only and the authority value of the group G3 is 3, which is lower than the authority value 2 of the group G2, the status updating unit 37 does not send the status of the presentity D in the group G2 to the watcher E. The flow then goes to step S7.

According to step S7, the watchers A, B, C, and E of the presentity D are all checked. The flow then returns to step S5.

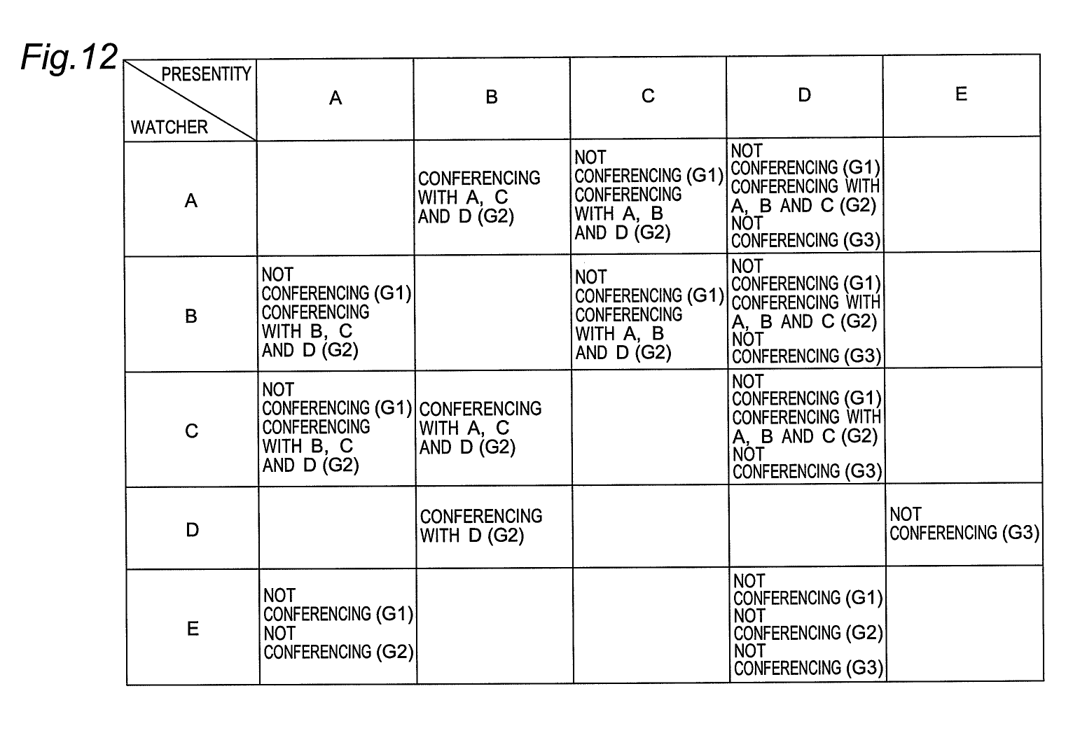

According to step S5, the status of the status-changed presentities A, B, C, and D in the status-changed group G2 have all been sent to their respective watchers at this time. The flow then returns to step S2. The status of the presentities A to E in the groups G1 to G3 as obtained by the watchers A to E at this time are shown in FIG. 12.

Later, the presentities A, C and D belonging to the group G1 start another conference. Therefore, the connection server sends the latest group status to the transmission unit 33.

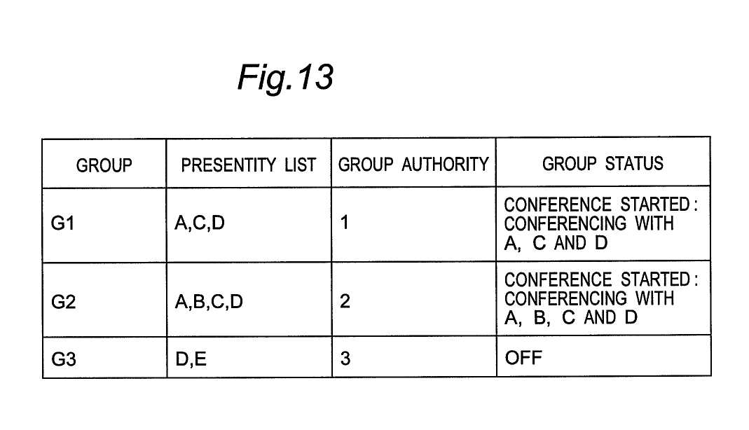

According to step S2, the group setting unit 34 updates the status of the group G1 in the group configuration database 31 according to the latest group status as “conference started: A, C and D are conferencing,” as shown in FIG. 13.

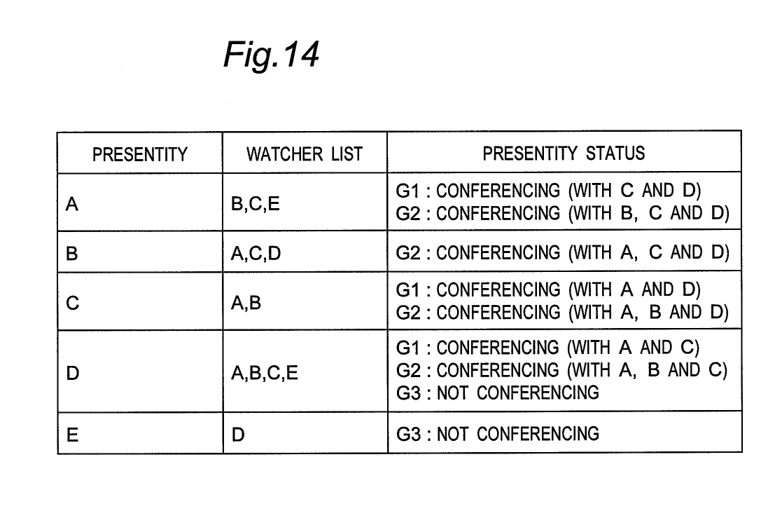

According to step S3, the presentity status checking unit 35 modifies the status of the presentities A, C and D in the group G1 according to the latest status of the group to “conferencing with C and D,” “conferencing with A and D,” and “conferencing with A and C,” respectively. Thus, the contents of the list database 32 will be such as those shown in FIG. 14.

According to step S4, the presentity status checking unit 35 makes a list of status-changed presentities according to the latest group status. The list of presentities includes the presentities A, C and D.

According to step S5, the presentity status checking unit 35 finds that the status of the status-changed presentities A, C and D have yet to be sent to any watcher at this time. The flow then goes to step S6.

According to step S6, the authority comparison unit 36 obtains a watcher list for the presentity A, which includes watchers B, C and E.

According to step S7, the authority comparison unit 36 determines that each of the watchers in the watcher list of the presentity A has yet to receive the updated status. The flow then goes to step S8.

According to step S8, since the authority value 2 of the watcher B watching the presentity A is lower than the authority value 1 of the status-changed group G1, the status updating unit 37 will not send the status of the presentity A in the group G1 to the watcher B. The flow then returns to step S7.

According to step S7, the authority comparison unit 36 determines that the watcher C in the watcher list of the presentity A has yet to receive the updated status. The flow then goes to step S8.

According to steps S8, S9, and S10, since the authority value 1 of the watcher C watching the presentity A is not lower than the authority value 1 of the status-changed group G1, the status updating unit 37 records the status of the presentity A in the group G1 as “conferencing with C and D.” Since the presentity A also belongs to another group, the flow skips to step S11.

According to step S11, the presentity status checking unit 35 finds that the presentity A also belongs to the group G2.

According to step S12, the status of the presentity A in the group G2 is yet to be checked. Therefore, the flow goes to step S13.

According to steps S13, S14 and S15, since the authority value 1 of the watcher C is not lower than the authority value 2 of the group G2, the status updating unit 37 sends the status of the presentity A in the group G2, “conferencing with B, C and D,” and the status of the presentity A in the group G1, “conferencing with C and D,” to the watcher C. The flow then returns to step S7.

According to step S7, the authority comparison unit 36 determines that the watcher E of the presentity A has yet to receive the updated status. The flow then goes to step S8.

According to step S8, since the authority value 3 of the watcher E is lower than the authority value 1 of the status-changed group G1, the status updating unit 37 does not send the status of the presentity A in the group G1 to the watcher E. The flow then returns to step S7.

According to step S7, the authority comparison unit 36 determines that the watchers of the presentity A have all received the updated status. The flow then returns to step S5.

According to steps S5 and S6, the presentity status checking unit 35 finds that the watchers A and B of the presentity C have yet to receive the latest status at this time. The flow then goes to step S7.

According to steps S7 to S15, the authority comparison unit 36 determines that the authority value of the watcher A is 1 and is not lower than the authority value 1 of the status-changed group G1. Therefore, the status of the presentity C in the group G1, “conferencing with A and D,” and the status of the presentity C in the group G2, “conferencing with A, B and D,” are sent to the watcher A. The flow then goes to step S7.

According to steps S7 and S8, the authority comparison unit 36 determines that the authority value of the watcher B is 2, and is lower than the authority value 1 of the status-changed group G1. Therefore, the status of the presentity C in the group G1 is not sent to the watcher B. The flow then goes to step S7.

According to step S7, the authority comparison unit 36 determines that the watchers of the presentity C have all received the updated status. The flow then returns to step S5.

According to steps S5 and S6, the presentity status checking unit 35 finds that the watchers A, B, C, and E of the presentity D have yet to receive the latest status at this time. The flow then goes to step S7.

According to steps S7 to S15, the authority comparison unit 36 determines that the authority value of the watcher A is 1, and is not lower than the authority value 1 of the status-changed group G1. Therefore, the status of the presentity D in the group G1, “conferencing with A and C,” and the status of the presentity D in the group G2, “conferencing with A, B and C,” are sent to the watcher A. The flow then goes to step S7.

According to steps S7 and S8, the authority comparison unit 36 determines that the authority value of the watcher B is 2 and is lower than the authority value 1 of the status-changed group G1. Therefore, the status of the presentity D in the group G1 is not sent to the watcher B. The flow then goes to step S7.

According to steps S7 to S15, the authority comparison unit 36 determines that the authority value 1 of the watcher C is 1 and is not lower than the authority value 1 of the status-changed group G1. Therefore, the status of the presentity D in the group G1, “conferencing with A and C,” and the status of the presentity D in the group G2, “conferencing with A, B and C,” are sent to the watcher C. The flow then goes to step S7.

According to steps S7 and S8, the authority comparison unit 36 determines that the authority value of the watcher E is 3 and is lower than the authority value 1 of the status-changed group G1. Therefore, the status of the presentity D in the group G1 is not sent to the watcher E. The flow then goes to step S7.

According to step S7, the authority comparison unit 36 determines that the watchers of the presentity D have all received the updated status. The flow then returns to step S5.

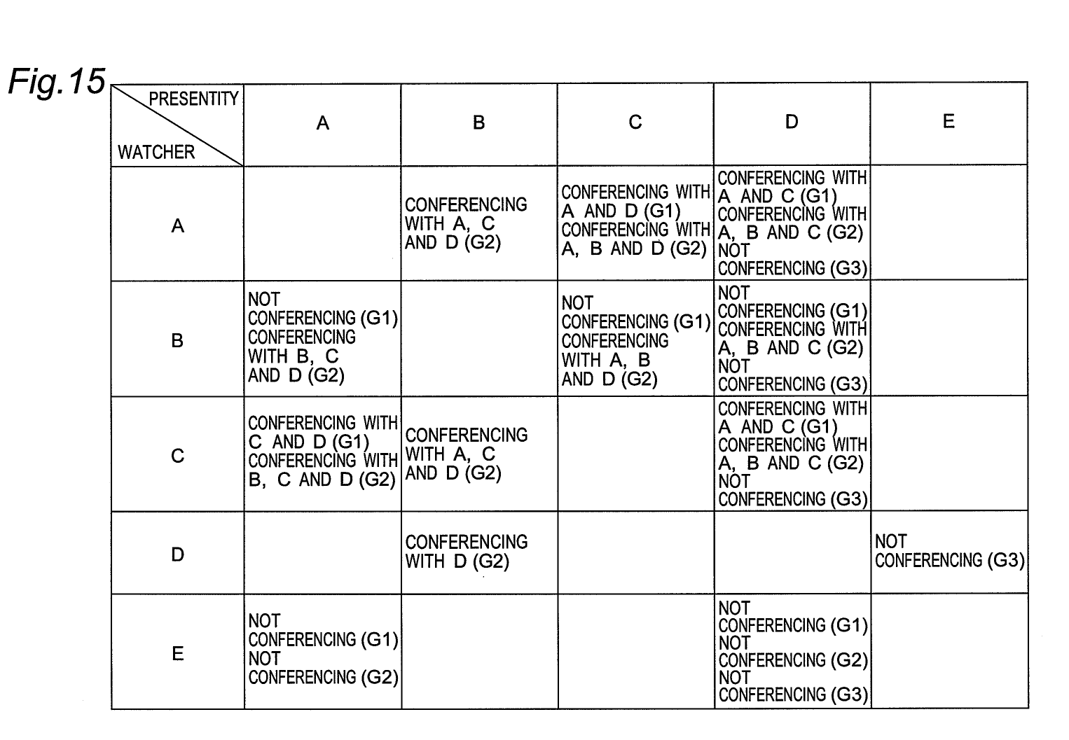

According to step S5, the presentity status checking unit 35 finds that the status of the status-changed presentities A, C and D have been sent to their respective watchers at this time. The status obtained by the watchers A to E at this time are shown in FIG. 15. The flow then returns to step S2, in which the server for providing status continues to receive the latest status of the other groups.

It is noted that the server for providing presentity status of this invention may also exclude the group configuration database 31 and the group setting unit 34, and the authority value of each group, and group configurations, such as the list of presentities belonging to each group, can be obtained from the connection server through the communications network. The authority comparison unit 36 receives the group authority values previously received by the transmission unit 33 through the presentity status checking unit 35, and determines the authority relationship between a presentity and a watcher according to the group authority.

In addition, it is noted that, in this embodiment, while the latest status is sent to the watcher only when the highest authority value of the groups to which the watcher belongs is not lower than the authority value of the group to which the presentity belongs, the present invention is not limited thereto. Alternatively, a predetermined condition can be set such that the latest status will be sent to the watcher only when the highest authority value of the groups to which the watcher belongs and the authority value of the group to which the presentity belongs satisfy the predetermined conditions.

In sum, the server for providing presentity status according to the present invention determines whether or not to notify the watcher of the latest status of a presentity in a group according to the authority of the group the presentity is in and the highest authority value of the groups to which the watcher belongs. Therefore, there is no need to set many complicated rules and determination conditions with respect to every presentity and all the watchers thereof and make relevant comparisons, thereby achieving the objective of enhancing operating efficiency. Furthermore, since all the members (i.e., presentities) of a company or an organization are grouped into different departments, the present invention can be implemented under the existing groups.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### INDUSTRIAL APPLICABILITY

The present invention can be used in a server for providing presentity status.

1. A method for providing presentity status, which is adapted for providing the latest status of a presentity to a watcher, the presentity and the watcher being respectively connected to a connection server through a network, the presentity belonging to at least one group, the watcher belonging to at least one group, each of the groups having a preset authority value, the connection server being capable of detecting the latest status of the groups to which the presentity belongs, said method comprising the following steps:
(A) when a preset situation is satisfied, the connection server receiving the latest status of the groups to which the presentity belongs;
(B) comparing the highest authority value of the groups to which the watcher belongs with the respective authority values of the groups to which the presentity belongs; and
(C) when the highest authority value of the groups to which the watcher belongs and the respective authority values of the groups to which the presentity belongs satisfies a preset condition, sending the latest status of the presentity in the groups thereof to the watcher.

2. The method for providing presentity status according to claim 1, wherein, in step (C), when the latest status of the presentity in the groups thereof is sent to the watcher, the latest group status of the groups to which the presentity belongs is also sent to the watcher.

3. The method for providing presentity status according to claim 1, wherein, before step (B), the watcher has submitted a subscription request for the latest status of the presentity in advance.

4. The method for providing presentity status according to claim 3, wherein, in step (C), when the latest status of the presentity in the groups thereof is sent to the watcher, the latest status of other presentities that are in the same groups as the presentity and that are subscribed to by the watcher are also sent to the watcher.

5. The method for providing presentity status according to claim 1, further comprising a step between steps (A) and (B): organizing a list of groups to which the presentity belongs, the list of groups including the latest status of the groups that the presentity belongs to and has joined, wherein, in step (B), comparison is made with reference to the list of groups.

6. The method for providing presentity status according to claim 5, wherein, in step (C), the preset condition is that the highest authority value of the groups to which the watcher belongs is not lower than the respective authority values of the groups to which the presentity belongs.

7. The method for providing presentity status according to claim 1, wherein, in step (B), the authority value of each group is set by the connection server.

8. The method for providing presentity status according to claim 1, wherein, in step (B), the authority value of each group is set by an administrator of the network.

9. The method for providing presentity status according to claim 1, wherein, in step (C), the preset condition is that the highest authority value of the groups to which the watcher belongs is not lower than the respective authority values of the groups to which the presentity belongs.

10. The method for providing presentity status according to claim 1, wherein, in step (A), the preset situation includes the occurrence of a change in the status of the presentity in the groups to which the presentity belongs.

11. The method for providing presentity status according to claim 10, wherein the change in the status of the presentity in the groups to which the presentity belongs includes the presentity's starting to join a conference of the group, the presentity's ending the conference of the group, the presentity's joining the group, the presentity's leaving the group, the presentity's being set to join the group, and the presentity's being set to be removed from the group.

12. The method for providing presentity status according to claim 1, wherein, in step (A), the preset situation includes the occurrence of a change in the status of the groups to which the presentity belongs.

13. The method for providing presentity status according to claim 1, wherein, in step (A), the preset situation includes the occurrence of a change in the respective authority values of the groups to which the presentity belongs, and the occurrence of a change in the respective authority values of the groups to which the watcher belongs.

14. The method for providing presentity status according to claim 1, wherein, in step (A), the preset situation includes the occurrence of a change in the preset condition.

15. The method for providing presentity status according to claim 1, wherein, in step (A), the preset situation includes an elapsed time since the latest status of the presentity in the groups was last sent to the watcher being greater than or equal to a specific time.

16. A server for providing presentity status, which is adapted to provide the latest status of a presentity to a watcher, the presentity and the watcher being respectively connected to a connection server through a network, the presentity belonging to at least one group, the watcher belonging to at least one group, the connection server being capable of detecting the latest status of the groups to which the presentity belongs, said server for providing presentity status comprising:
a database unit for respectively storing the current status of the groups to which the presentity belongs;
a transmission unit electrically connected to the connection server, for receiving the latest status of the groups to which the presentity belongs through the connection server when a preset situation is satisfied;
a presentity status checking unit electrically connected to said transmission unit, for receiving the latest status of the groups to which the presentity belongs through said transmission unit, and updating the status in said database unit according to the received latest status;
an authority comparison unit for comparing the highest authority value of the groups to which the watcher belongs with the respective authority values of the groups to which the presentity belongs; and
a status updating unit electrically connected to said authority comparison unit, said database unit, and said transmission unit, for receiving a comparison result from said authority comparison unit such that when the comparison result satisfies a preset condition, the latest status of the presentity in the groups thereof as recorded in said database unit is sent to the watcher through said transmission unit.

17. The server for providing presentity status according to claim 16, wherein, when the preset situation is satisfied, said presentity status checking unit receives the latest group status of the groups to which the presentity belongs through said transmission unit, and stores the latest group status in said database unit, said status updating unit also sending the latest group status of the groups to which the presentity belongs to the watcher through said transmission unit when the comparison result satisfies the preset condition.

18. The server for providing presentity status according to claim 16, wherein said transmission unit receives a subscription request for the latest status of the presentity from the watcher.

19. The server for providing presentity status according to claim 18, wherein, when the preset situation is satisfied, said presentity status checking unit receives the latest status of other presentities in the same groups that the presentity belongs to and that the watcher subscribes to through said transmission unit, and stores the latest status in said database unit, said status updating unit also sending the latest status of other presentities in the same groups that the presentity belongs to and that the watcher subscribes to through said transmission unit when the comparison result satisfies the preset condition.

20. The server for providing presentity status according to claim 16, wherein said presentity status checking unit organizes a list of groups to which the presentity belongs, said list of groups including the latest status of the groups that the presentity belongs to and has joined, said authority comparison unit making comparisons with reference to the list of groups.

21. The server for providing presentity status according to claim 20, wherein the preset condition is that the highest authority value of the groups to which the watcher belongs is not lower than the respective authority values of the groups to which the presentity belongs.

22. The server for providing presentity status according to claim 16, wherein the authority value of each group is sent to said transmission unit by the connection server.

23. The server for providing presentity status according to claim 16, wherein the authority value of each group is determined and sent to said transmission unit by an administrator of the network.

24. The server for providing presentity status according to claim 16, wherein the preset condition is that the highest authority value of the groups to which the watcher belongs is not lower than the respective authority values of the groups to which the presentity belongs.

25. The server for providing presentity status according to claim 16, wherein the preset situation includes the occurrence of a change in the status of the presentity in the groups to which the presentity belongs.

26. The server for providing presentity status according to claim 25, wherein the change in the status of the groups to which the presentity belongs includes the presentity's starting to join a conference of the group, the presentity's ending the conference of the group, the presentity's joining the group, the presentity's leaving the group, the presentity's being set to join the group, and the presentity's being set to be removed from the group.

27. The server for providing presentity status according to claim 16, wherein the preset situation includes the occurrence of a change in the status of the groups to which the presentity belongs.

28. The server for providing presentity status according to claim 16, wherein the preset situation includes the occurrence of a change in the respective authority values of the groups to which the presentity belongs and the occurrence of a change in the respective authority values of the groups to which the watcher belongs.

29. The server for providing presentity status according to claim 16, wherein the preset situation includes the occurrence of a change in the preset condition.

30. The server for providing presentity status according to claim 16, wherein the preset situation includes an elapsed time since the latest status of the presentity in the groups was last sent to the watcher being greater than or equal to a specific time.

31. The server for providing presentity status according to claim 16, wherein said database unit respectively stores the authority values of the groups to which the presentity belongs and the authority values of the groups to which the watcher belongs, and said authority comparison unit is electrically connected to said database unit, and searches data in said database unit so as to obtain authority values of the groups.

32. The server for providing presentity status according to claim 16, further comprising a group setting unit electrically connected to said transmission unit, where said group setting unit sets a list of presentities in each group, status of each group, and authority value of each group according to information received from said transmission unit for storage in said database unit.

33. The server for providing presentity status according to claim 16, wherein said database unit includes a group configuration database, and a list database electrically connected to said presentity status checking unit, said group configuration database storing a list of presentities in each group, status of each group, and authority value of each group, said list database storing status of each presentity in each group, and a list of watchers subscribing to the status of each presentity, said presentity status checking unit being capable of updating the status in said list database.

34. The server for providing presentity status according to claim 16, wherein said presentity status checking unit receives the respective authority values of groups to which the presentity belongs and the respective authority values of the groups to which the watcher belongs through said transmission unit, and sends the authority values of the groups to said authority comparison unit.
